(19) United States
(12) Patent Application Publication
(10) Pub. No.: US 2024/0295952 A1
(43) Pub. Date: Sep. 5, 2024

(54) INFORMATION GENERATION APPARATUS, INFORMATION GENERATION METHOD, AND STORAGE MEDIUM

(71) Applicant: CASIO COMPUTER CO., LTD., Tokyo (JP)

(72) Inventor: Kota SAJI, Tokyo (JP)

(73) Assignee: CASIO COMPUTER CO., LTD., Tokyo (JP)

(21) Appl. No.: 18/430,759

(22) Filed: Feb. 2, 2024

(30) Foreign Application Priority Data
Mar. 1, 2023 (JP) 2023-031371

(51) Int. Cl. G06F 3/0484

(52) U.S. Cl. CPC G06F 3/0484

(57) ABSTRACT

An information generation apparatus performs processing of receiving a user's operation for designating a range in a first display area in which information that is input in response to a user's operation is displayed, recognizing a calculation expression from displayed elements included in the designated range, and generating or editing a first electronic sticky note that can be arranged and displayed at a designated position within the designated display area and to which a first calculation expression, which is the recognized calculation expression, is input.

### CROSS-REFERENCE TO RELATED APPLICATION(S)

This application is based upon and claims the benefit of priority from prior Japanese Patent Application No. 2023-031371, filed Mar. 1, 2023, the entire contents of which are incorporated herein by reference.

### FIELD

The present disclosure relates to an information generation apparatus, an information generation method, and a storage medium.

### BACKGROUND

In a conventional calculation apparatus comprising a writing inputting means, in response to an operation (gesture) of circling a trajectory of a calculation expression that is input by handwriting to a display area, calculation elements of the calculation expression are recognized in the trajectory and calculation is performed (see Jpn. Pat. Appln. KOKAI Publication No. 2011-053986, for example).

### SUMMARY

An information generation apparatus according to the present disclosure is configured to perform a process of:
receiving a user's operation for designating a range in a first display area displaying information that is input in response to a user's operation;
recognizing a calculation expression from displayed elements included in the designated range; and
generating or editing a first electronic sticky note that can be arranged and displayed at a designated position in the designated display area and to which a first calculation expression, which is the recognized calculation expression, is input.

### BRIEF DESCRIPTION OF THE DRAWINGS

FIG. 1 is a drawing showing an overall configuration of an information generation system 1 according to an embodiment of an information generation apparatus, an information generation method, and a program of the present disclosure.

FIG. 2 is a block diagram showing a configuration of electronic circuitry of an information generation server 10.

FIG. 3 is a diagram showing a sticky note management table (12d) stored in a sticky note management table data storage area 12d of the information generation server 10.

FIG. 4 is a block diagram showing a configuration of electronic circuitry of a user terminal 20.

FIG. 5 is a flowchart showing an electronic sticky note generation process according to a server control program 12a of the information generation server 10.

FIG. 6 is a diagram showing a screen change on the user terminal 20 side according to the electronic sticky note generation process in the information generation server 10.

FIG. 7 is a flowchart showing a calculation expression data conversion process according to a server control program 12a of the information generation server 10.

FIG. 8 is a flowchart showing an electronic sticky note automatic generation process according to a server control program 12a of the information generation server 10.

FIG. 9 is a diagram showing a display operation on the user terminal 20 side according to the calculation expression data conversion process in the information generation server 10.

FIG. 10 is a diagram showing a display operation (part 1) on the user terminal 20 side according to the electronic sticky note automatic generation process in the information generation server 10.

FIG. 11 is a diagram explaining data conversion of a calculation expression and division of a calculation expression according to the calculation expression data conversion process and the electronic sticky note automatic generation process in the information generation server 10.

FIG. 12 is a diagram showing a display operation (part 2) on the user terminal 20 side according to the electronic sticky note automatic generation process in the information generation server 10.

FIG. 13 is a diagram showing a display operation (part 3) on the user terminal 20 side according to the electronic sticky note automatic generation process in the information generation server 10.

FIG. 14 is a diagram showing other modes of displaying calculation expressions Mt11, Mt12, Mt13 and results of true-or-false determinations on these expressions displayed in an electronic sticky note NB2-2 in accordance with the electronic sticky note automatic generation process in the information generation server 10.

FIG. 15 is a diagram showing a notebook window G2 of a notebook (mathematics) NB2 including electronic sticky notes (point 1) NB2-2 and electronic sticky notes (point 2) NB2-3 newly added to the notebook (mathematics) NB2 in accordance with the electronic sticky note automatic generation process in the information generation server 10.

### DETAILED DESCRIPTION

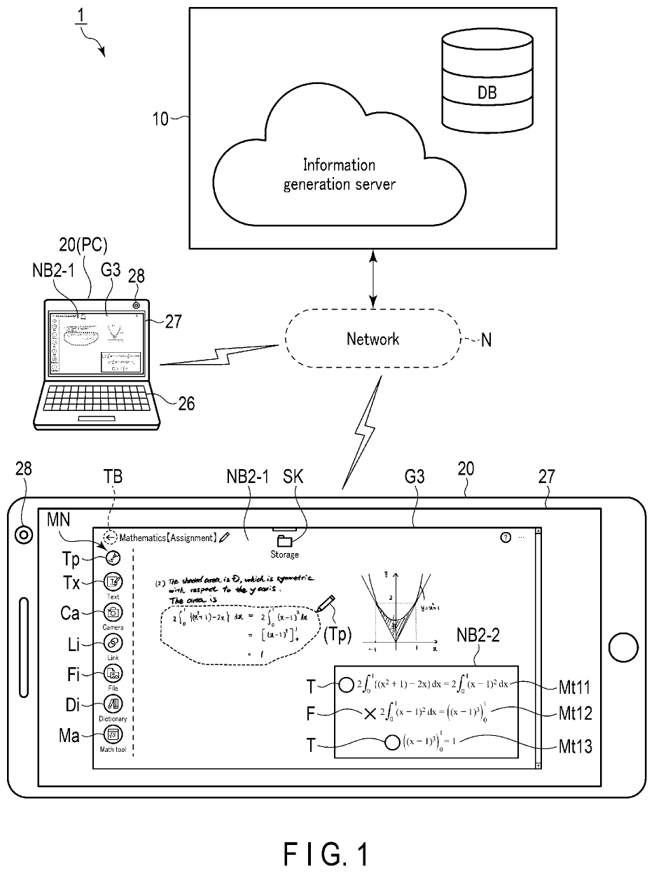

FIG. 1 is a drawing showing an overall configuration of an information generation system 1 according to an embodiment of an information generation apparatus, an information generation method, and a program of the present disclosure.

The information generation system 1 is constituted by an information generation server 10 (server apparatus) provided on a communication network N such as the Internet, and a user terminal 20 (communication device) that connects to and uses the information generation server 10.

Herein, the information generation server 10 is a dedicated server that connects an information-generation-server-using application for using the information generation server 10 to a cloud service. The information generation server 10 and the user terminal 20 may serve as an information generation apparatus of the present disclosure.

The user terminal 20 (communication device) may be configured as a tablet device having a communication function, a smartphone, a PC, an electronic dictionary, a mobile phone, an electronic book, and a portable game player.

An information-generation-server-using application program (information-generation-server-using application) is installed on the user terminal 20.

The information generation server 10 has at least the following functions (10a) to (10g) if it is connected to the user terminal 20 in accordance with an information-generation-server-using application of the user terminal 20.

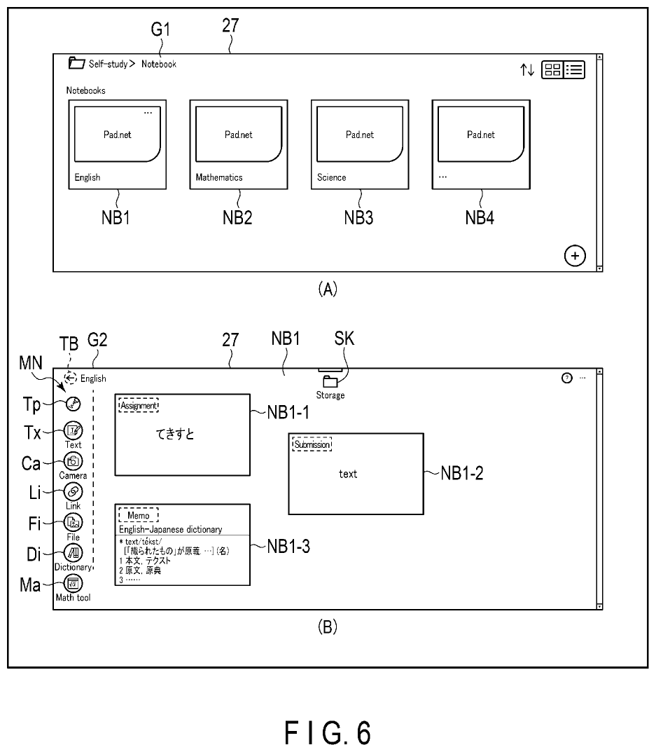

(10a) Function of generating, in response to an operation of the user terminal 20, a notebook window G2 of a display area (notebook NB1; see FIG. 6) with which a user can input discretionarily selected information and display it, and causing the notebook window G2 to be displayed on the display unit 27 of the user terminal 20.

(10b) Function of generating electronic sticky notes NB1-1 through NB1-3 to which a type of information selected from the notebook menu MN is input in response to a user's operation of the notebook menu MN provided on the notebook window G2, and causing the electronic sticky notes to be placed and displayed at a user's discretionarily selected positions in the notebook NB1.

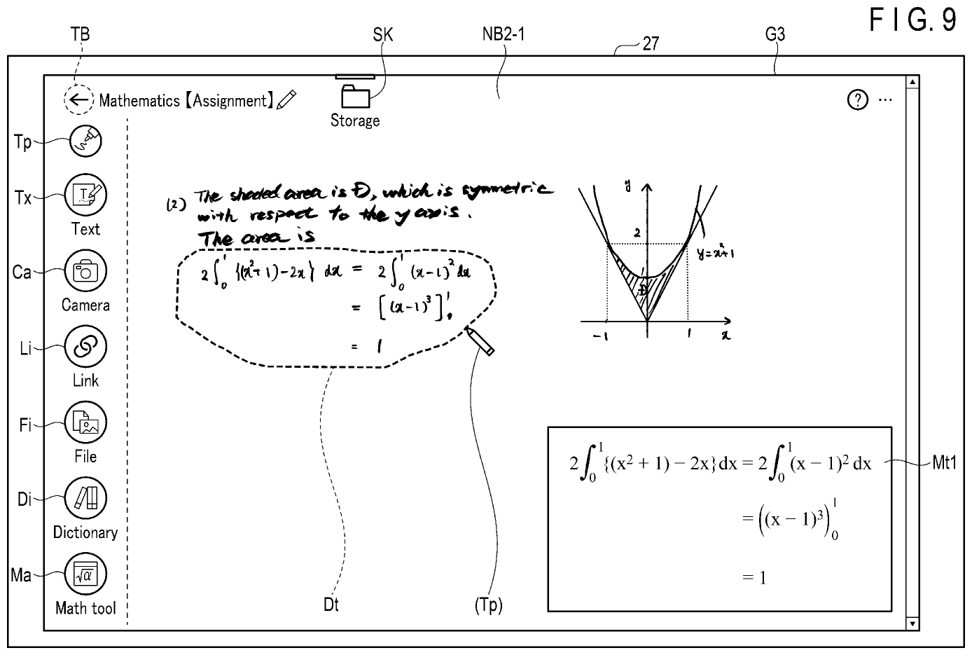

(10c) Function of recognizing a calculation expression constituted by a plurality of calculation elements among displayed elements (trajectories that are input by handwriting or text that is input with keys) included in a range Dt designated by a user's operation on a display area of the touch-panel type display unit 27, and causing the calculation expression as calculation expression Mt1 converted into data in a predetermined font (see FIG. 9) to be displayed.

(10d) If multiple “=” (equal signs) are included in a recognized calculation expression, function of dividing the calculation expression at each “=” (equal sign) into equations Mt11, Mt12, and Mt13, each having a left side and a right side (if there is one “=” (equal sign), the expression will be a single equation Mt1 having a left side and a right side), generating an electronic sticky note NB2-2 to which the equations Mt11, Mt12, Mt13 are input (or separate electronic sticky notes for each equation), and causing the electronic sticky note NB2-2 to be displayed.

(10e) Function of performing a calculation of comparing the left side and the right side of each of the equations Mt11, Mt12, and Mt13 and making a true-or-false determination on the respective equations, and displaying the equations to which the determination results (“true” T/“false” F) are respectively added.

(10f) Function of performing calculation represented by a calculation expression if no “=” (equal sign) is included in a recognized calculation expression, and generating an electronic sticky note NBm-n in which a calculation result is added to the calculation expression and causing the note to be displayed.

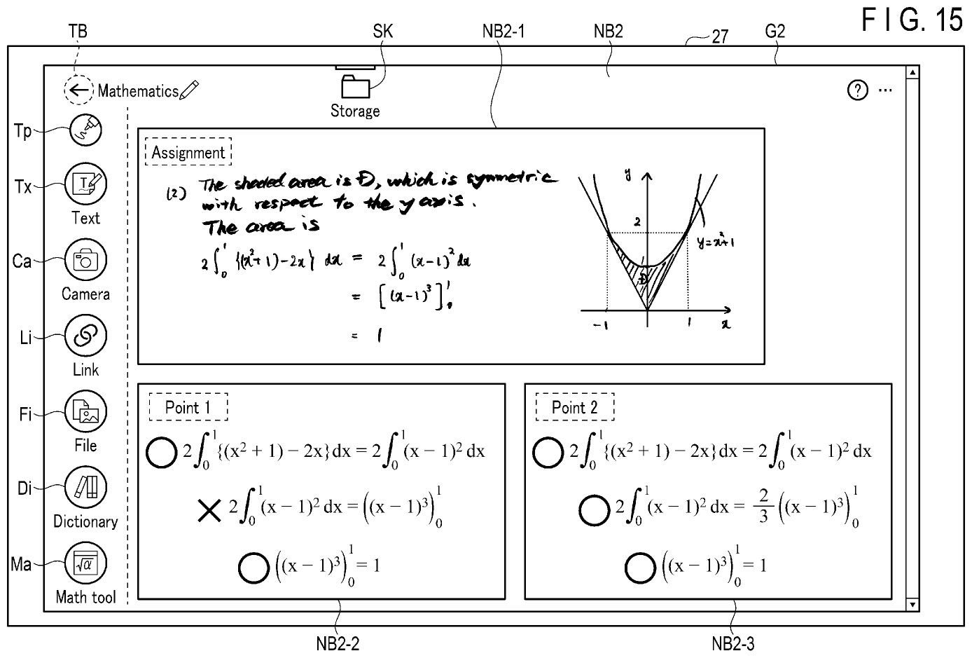

(10g) Function of storing an electronic sticky note NBm-n that includes a recognized calculation expression in association with a discretionarily selected position of a user's discretionarily selected notebook NBm (see FIG. 15).

In the embodiment, the symbol NBm (e.g., NB1, NB2) indicates a notebook ID (identification information) but may be read as a notebook name that is input by a user (for example, the name of a subject that the user is studying, such as “English”, “mathematics”, or “science”). The symbol NBm-n (e.g., NB1-1, NB1-2) indicates an electronic sticky note ID generated in the notebook NBm but may be read as a name of an electronic sticky note that is input by a user (for example, a title of a subject that the user is studying, such as “assignment”, “submission”, or “important points”).

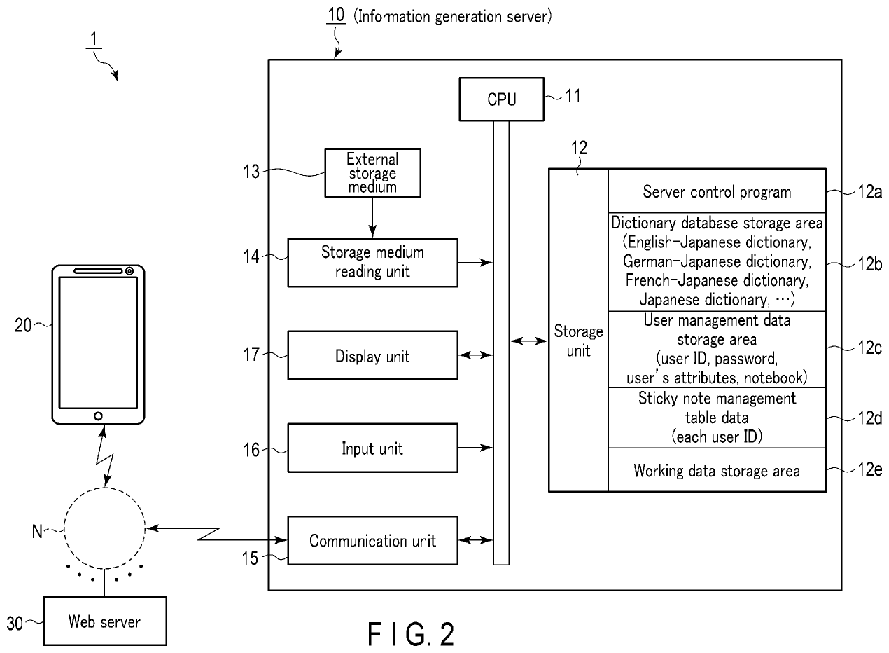

FIG. 2 is a block diagram showing a configuration of electronic circuitry of the information generation server 10.

The electronic circuitry of the information generation server 10 includes a control unit (central processing unit, CPU) 11, which is a computer, a storage unit 12, a storage medium reading unit 14, a communication unit 15, an input unit 16, and a display unit 17.

The control unit 11 controls, in accordance with the server control program 12a stored in the storage unit 12, an operation of each unit in the circuitry in accordance with an input signal from the input unit 16 in response to a user's operation or a signal from a user terminal 20 on a communication network N by the communication unit 15.

The server control program 12a may be stored in the storage unit 12 in advance, read from an external storage medium 13, such as a CD-ROM, through the storage medium reading unit 14 and stored in the storage unit 12, or downloaded from a Web server (in this case, the program server 30) on a communication network N and stored in the storage unit 12.

The server control program 12a includes a program for executing at least the foregoing functions (10a) through (10g).

The storage unit 12 secures a dictionary database storage area 12b, a user management data storage area 12c, a sticky note management table data storage area 12d, and a working data storage area 12e, in addition to the storage area of the server control program 12a.

In the dictionary database storage area 12b, data of various dictionaries, such as an English-Japanese dictionary, a German-Japanese dictionary, a French-Japanese dictionary, and a Japanese dictionary, are stored as dictionary data in which an entry word is associated with explanatory information (a translation of the entry word, a definition, example sentences, an explanation).

In the user management data storage area 12c, data of a user's registered password, a user's attributes (work (school), a grade year, etc.), and content of a notebook (NBm) including electronic sticky notes (NBm-n) generated in response to a user's operation are stored, along with a user ID (user identification information; herein, application ID), for each user of a user terminal 20 on which an information-generation-server-using application is installed, in association with a notebook ID and an electronic sticky note ID.

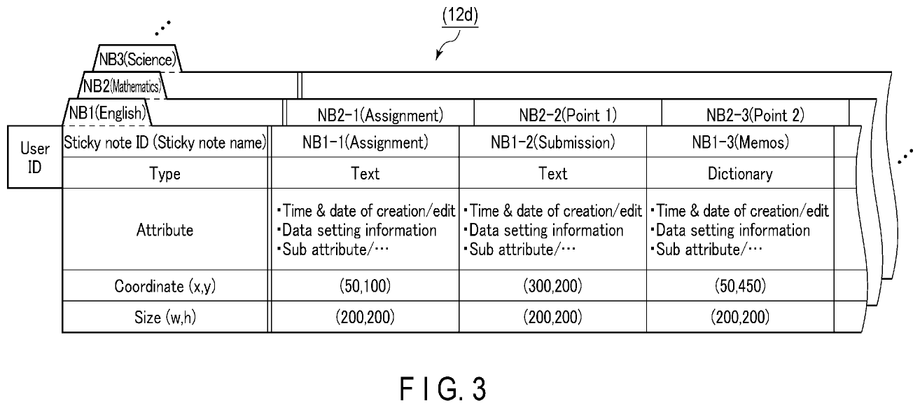

FIG. 3 is a diagram showing a sticky note management table 12d stored in a sticky note management table data storage area 12d of the information generation server 10.

In the sticky note management table (notebook management table) 12d, for each user ID stored (registered) in the user management data storage area 12c, in association with a notebook ID (notebook name) of a notebook (NBm) generated in accordance with a user's operation, an electronic sticky note ID (sticky note name) of an electronic sticky note (NBm-n) included in the notebook (NBm), a type of information selected from the notebook menu MN, data attributes included in the electronic sticky note (NBm-n) (date and time of creation/edit, data setting information such as a data format, sub-attributes, etc.), a coordinate of a display position in the notebook (NBm) of the electronic sticky note (NBm-n), and a size of the electronic sticky note (NBm-n) are stored.

The electronic sticky note table (12d) collectively stores management information of the electronic sticky notes (NBm-n) included in each notebook Nbm for a plurality of electronic sticky notes (NB1-n/NB2-n/NBm-n) included in each of the notebooks (NB1, NB2, . . . ), and is a management table for notebooks NBm with which stored management information can be updated in accordance with generation of a notebook NBm and electronic sticky notes (NBm-n) included in the notebook NBm and updating of information.

The working data storage area 12e may temporarily store various data generated or acquired by a control of an operation in each unit by the control unit 11, as needed.

The information generation server 10 configured in the above-described manner realizes various functions, which will be described later in connection with the explanation of the operations, through the control of an operation of each circuitry unit by the control unit 11 in accordance with an instruction described in the server control program 12a and an operation of software and hardware in conjunction.

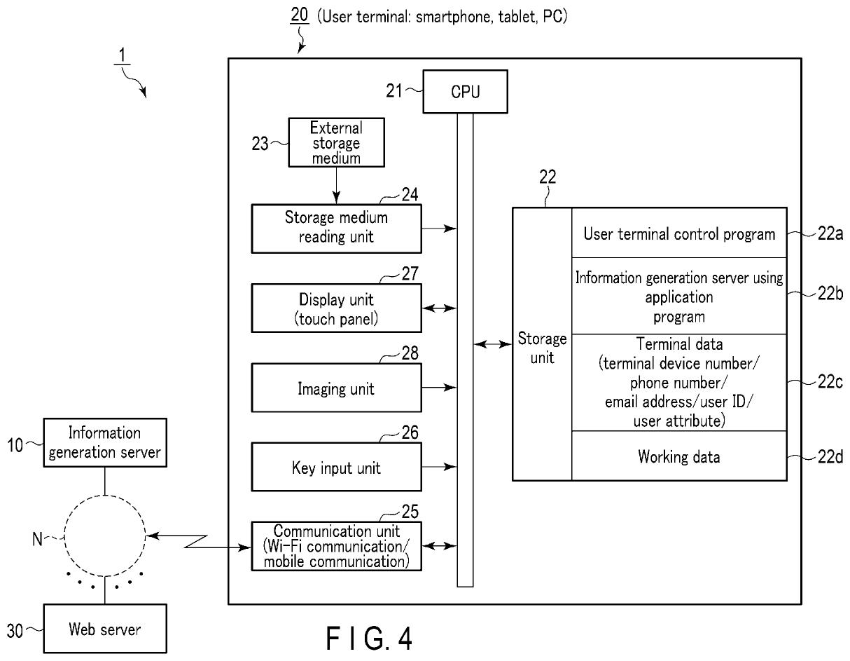

FIG. 4 is a block diagram showing a configuration of electronic circuitry of the user terminal 20.

The electronic circuitry of the user terminal 20 includes a control unit (CPU) 21, which is a computer, a storage unit 22, a storage medium reading unit 24, a communication unit (Wi-Fi (registered trademark) communication/mobile communication) 25, a key input unit 26, a touch-panel display unit 27, and an imaging unit 28.

The control unit 21 controls an operation of each circuitry unit in accordance with the user terminal control program 22a and the information-generation-server-using application program (information-generation-server-using application) 22b stored in the storage unit 22. The user terminal control program 22a may be stored in the storage unit 22 in advance, or may be read from the external storage medium 23 such as a memory card by the storage medium reading unit 24 and stored in the storage unit 22, or may be downloaded from the Web server (program server in this example) 30 on a communication network N via the communication unit 25 and stored in the storage unit 22.

The information-generation-server-using application 22b is downloaded from the Web server (a program server in an application store in this example) 30 on a communication network N via the communication unit 25 and stored in the storage unit 22.

The user terminal control program 22a includes, other than a system program for controlling the entire user terminal 20, a program for connecting to and communicating with an external device including the information generation server 10 and the Web server 30 on the communication network N in conjunction with various application programs stored in the storage unit 22.

The information-generation-server-using application 22b includes a program for executing data input/output processing in accordance at least with the foregoing functions (10a) to (10g) through a communication connection with the information generation server 10.

Aside from the storage unit 22, the storage medium reading unit 24, and the communication unit 25, a key input unit 26, a touch-panel display unit 27, and an imaging unit (camera) 28 are connected to the control unit 21 via the system and data bus.

In the storage unit 22, a terminal device data storage area 22c and a working data storage area 22d are secured, in addition to a program storage area for storing a user terminal control program 22a and an information-generation-server-using application 22b.

In the terminal device data storage area 22c, aside from terminal device numbers for communicating with and connecting to an external communication device including the information generation server 10 and Web server 30 on the communication network N, data of telephone numbers, mail addresses, user ID's (user identification information; an application ID in this example), and user's attributes (work (school)/a year in school) are stored as terminal data unique to the user terminal 20.

The working data storage area 22d may temporarily store various data generated or acquired by a control of an operation in each unit by the control unit 21, as needed.

The user terminal 20 with the above-described configuration controls, through the control unit 21, an operation of each circuitry unit in accordance with an instruction described in the user terminal control program 22a and the information-generation-server-using application 22b, and realizes various functions, which will be described later in connection with the explanations of operation, through an operation with a collaboration between software and hardware.

### Operation According to Embodiment

Next, an operation of the information generation system 1 of the embodiment is described.

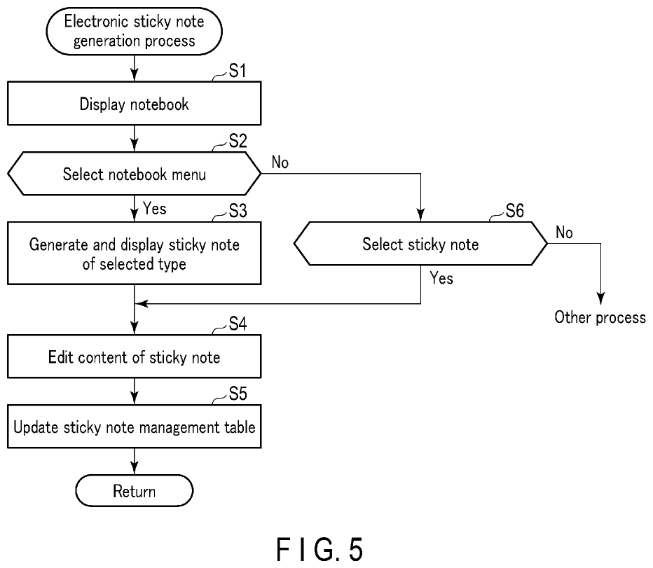

FIG. 5 is a flowchart showing an electronic sticky note generation process according to the server control program 12a of the information generation server 10.

FIG. 6 is a diagram showing a screen change on the user terminal 20 side according to the electronic sticky note generation process in the information generation server 10.

In the information generation server 10, the control unit 11, while it is communicating with and being connected to the user terminal 20 in accordance with a login request from the user terminal 20, causes the touch-screen display unit 27 of the user terminal 20 to display the notebook NBm (herein NB1 through NB4) generated in accordance with a user's operation as shown in FIG. 6(A), as a notebook listing window G1 listing notebook icons (English: NB1/mathematics: NB2/science: NB3/ . . . ).

After the notebook icon (English: NB1) is designated by a touch operation in the notebook listing window G1, the control unit 11 reads data of the designated notebook NB1 from the user management data storage area 12c and causes the touch-screen display unit 27 to display the data as a notebook window G2 of the notebook (English) NB1 as shown in FIG. 6(B) based on the sticky note management table (12d) (step S1). The touch operation on the display screen may be a click operation by a mouse cursor or a combination of a designation operation and determination operation using a pointer device, and this applies to the descriptions hereinafter.

Herein, suppose the electronic sticky note NB1-n has not yet been generated in the notebook (English) NB1.

If a user wishes to generate an electronic sticky note NB1-n into which discretionarily selected information is input and attach the same on the notebook (English) NB1, if a button (Tx/Ca/Li/Fi/Di/Ma) indicative of information of a discretionarily selected type is selected from the notebook menu MN arranged on the left edge of the notebook window G2 (Yes in step S2), the control unit 11 generates an electronic sticky note NB1-n that can be generated by inputting the information of the selected type thereto and causes the electronic sticky note NB1-n to be displayed in the notebook NB1 (step S3).

The notebook menu MN includes, for example, a [Trimming] button Tp, a [Text] button Tx, a [Camera] button Ca, a [Link] button Li, a [File] button Fi, a [Dictionary] button Di, and a [Math tool] button Ma.

In response to a user selecting the [Text] button Tx, the control unit 11 causes a new electronic sticky note NB1-n to be displayed in the notebook NB1 and starts a text input application of the user terminal 20, and then inputs and displays discretionarily selected text in accordance with a user's operation to the electronic sticky note NB1-n and allows the text to be editable (step S4).

In response to a user selecting the [Camera] button Ca, the control unit 11 causes a new electronic sticky note NB1-n to be displayed in the notebook NB1 and starts the imaging unit (camera) 28 of the user terminal 20, and then inputs a photograph image taken by the imaging unit (camera) 28 to the electronic sticky note NB1-n to allow the photograph image to be displayable and editable (step S4).

In response to a user selecting the [Link] button Li, the control unit 11 causes a new electronic sticky note NB1-n to be displayed in the notebook NB1 and starts a Web browser of the user terminal 20, and then inputs a user's discretionarily selected Web page to the electronic sticky note NB1-n so as to allow the Web page to be displayable and editable (step S4).

In response to a user selecting the [File] button Fi, the control unit 11 causes a new electronic sticky note NB1-n to be displayed in the notebook NB1 and starts a file operation application of the user terminal 20, and then inputs a discretionarily selected file to the electronic sticky note NB1-n so as to allow the file to be displayable and editable (step S4).

In response to a user selecting the [Dictionary] button Di, the control unit 11 causes a new electronic sticky note NB1-n to be displayed in the notebook NB1 and starts a dictionary application of the server 10, and allows the user to search the dictionary database (12b) for a user's discretionarily selected entry word and explanation information thereof and display the word and information and makes the electronic sticky note NB1-n editable (step S4).

In response to a user selecting the [Math tool] button Ma, the control unit 11 causes a new electronic sticky note NB1-n to be displayed in the notebook NB1 and starts a mathematical tool application of the information generation server 10, and then, using a discretionarily selected mathematical tool, inputs mathematical data of a mathematical expression, a graph, or a statistic table to the electronic sticky note NB1-n and allows the mathematical data to be displayable and editable (including performing a calculation represented by a calculation expression and determination of true or false of a calculation expression) (step S4).

To perform display or editing of information on an electronic sticky note NBm-n corresponding to a button (Tx/Ca/Li/Fi/Di/Ma) of the notebook menu NM, display or editing can be performed by enlarging the size of the electronic sticky note NBm-n in the notebook NBm as an electronic sticky note editing window G3 (see FIG. 1).

The button indicating a type of information of the notebook menu MN is not limited to the foregoing [Text] button Tx, [Camera] button Ca, [Link] button Li, [File] button Fi, [Dictionary] button Di, or [Math tool] button Ma, but another button for inputting other types of information may be provided.

If the “trimming” button Tp provided at the top of the notebook menu NM is selected, the control unit 11 causes a trimming pen (Tp) to be displayed in a display area (e.g., the electronic sticky note editing window G3) of the electronic sticky note NBm-n in a displayable, editable state to check an image included in the range Dt designated by encircling the range by moving the trimming pen (Tp).

The electronic sticky note NBm-n displayed in the notebook NBm is moved to another display position by a user's touch operation and dragging (moving).

The color of the electronic sticky note NBm-n generated in the notebook NBm is changed to a discretionarily selected color in accordance with a user's operation.

After the electronic sticky note NBm-n to which a user's discretionarily selected information is input and which is arranged and displayed at a discretionarily selected position is generated, and a [←] (“close”) button TB on the notebook window G2 is touch-operated, the control unit 11 has the data of the generated electronic sticky note NBm-n as content of the notebook NBm of the user management data storage area 12c stored and has a type, attributes, a coordinate, a size of the sticky note management table (12d) stored in association with the electronic sticky note ID (step S5).

If the displayed electronic sticky note NBm-n to which a user's discretionarily selected information is input is dragged and dropped at the position of the [Store] icon SK, the control unit 11 associates the dropped electronic sticky note NBm-n with a discretionarily selected position of the user's discretionarily selected notebook NBm and stores the electronic sticky note NBm-n. The control unit 11 adds an electronic sticky note ID of the electronic sticky note NBm-n dropped to the [Store] icon SK in association with the corresponding notebook NBm in the sticky note management table (12d), and type, attribution, coordinate, and size are stored (step S5).

Herein, the notebook window G2 of the notebook (English) NB1 as shown in FIG. 6(B) for example shows a state of displaying two electronic sticky notes NB1-1 and NB1-2, which are generated by inputting text thereto based on an operation of the [Text] button Tx, and an electronic sticky note NB1-3 generated by searching a dictionary entry word and explanation information thereof based on an operation of the [Dictionary] button Di.

As shown in FIG. 6(B) for example, with the notebook window G2 of the notebook NB1 including the generated electronic sticky notes (herein NB1-1 through NB1-3) being displayed (step S1), if an electronic sticky note NB1-n is discretionarily selected (Yes in step S6), the control unit 11 additionally makes the content of the selected electronic sticky note NB1-n editable based on the notebook menu MN, as described earlier (step S4).

The electronic sticky note NBm-n generated in the notebook window G2 can be transmitted or received between a plurality of user terminals 20 that are set in advance between users based on the user management data (12c) and the sticky note management table (12d).

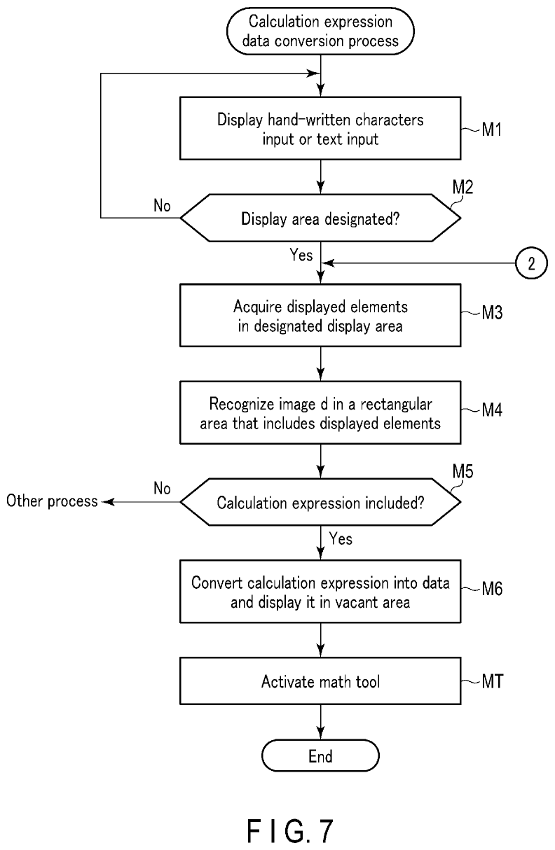

FIG. 7 is a flowchart showing a calculation expression data conversion process according to the server control program 12a of the information generation server 10.

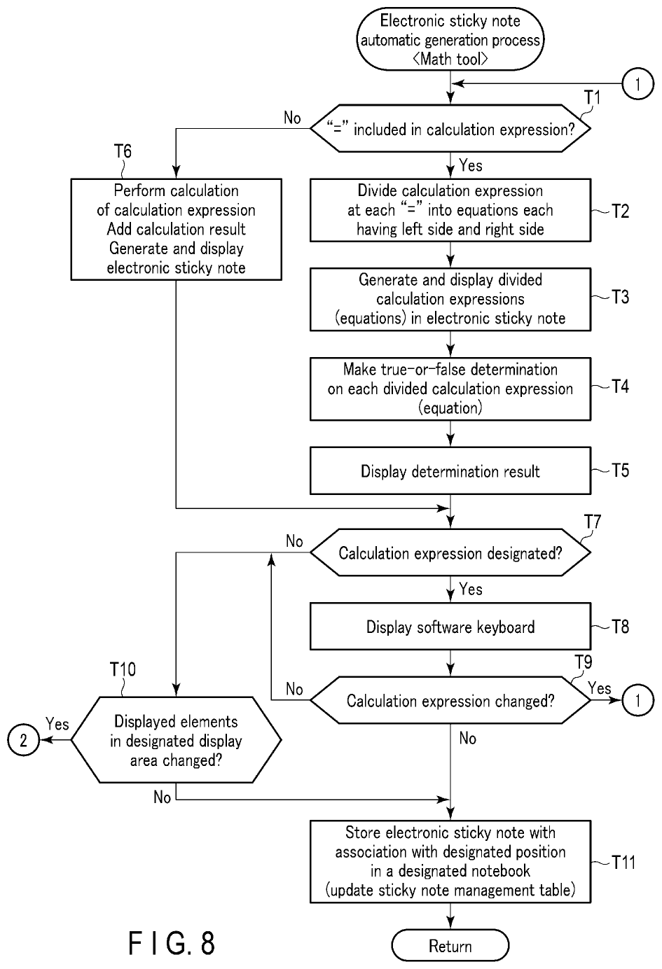

FIG. 8 is a flowchart showing an electronic sticky note generation process according to the server control program 12a of the information generation server 10.

FIG. 9 is a diagram showing a display operation on the user terminal 20 side according to the calculation expression data conversion process in the information generation server 10.

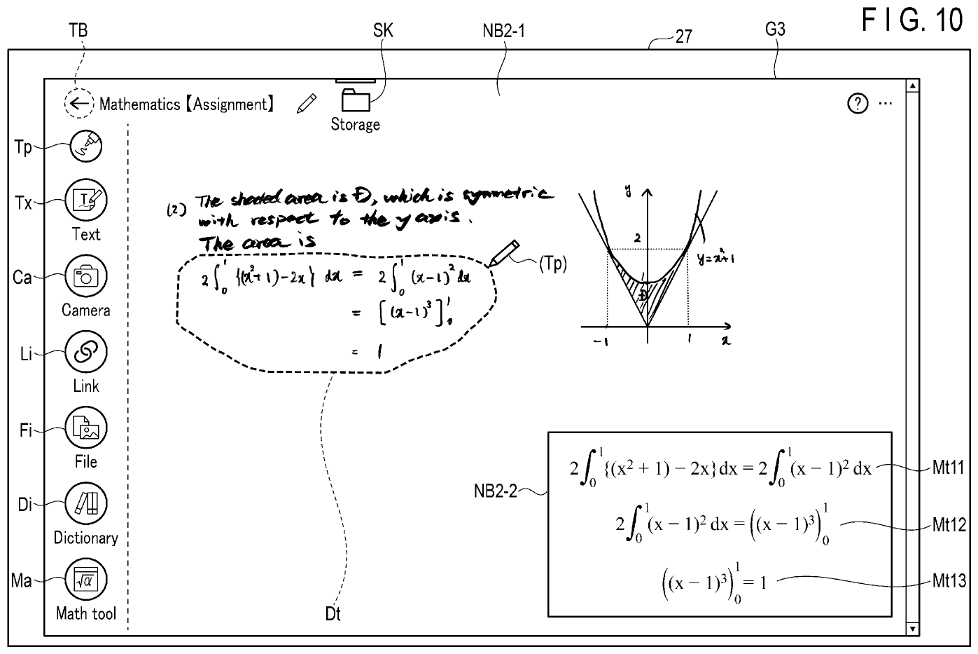

FIG. 10 is a diagram showing a display operation (part 1) on the user terminal 20 side according to the electronic sticky note automatic generation process in the information generation server 10.

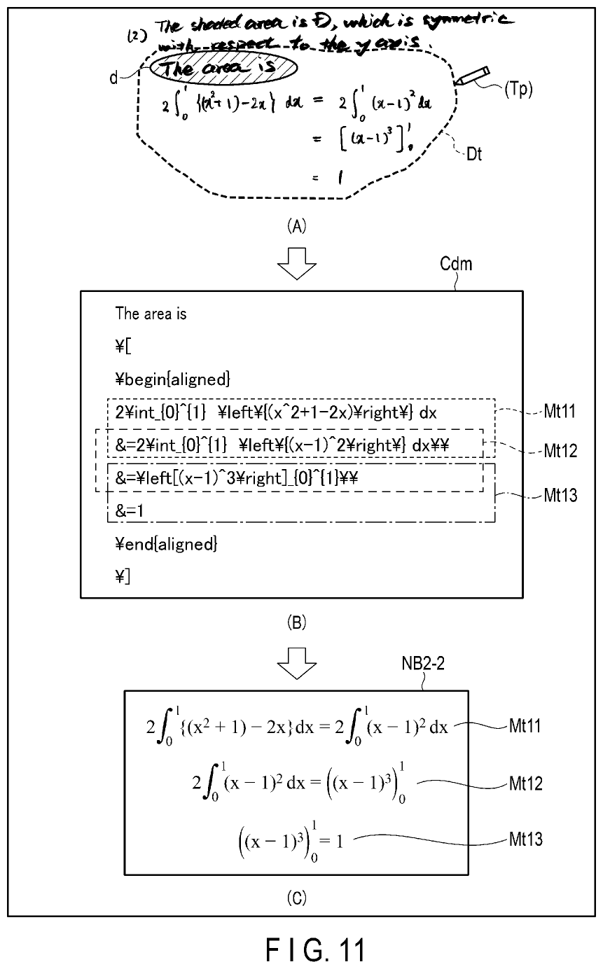

FIG. 11 is a diagram explaining data conversion of a calculation expression and division of a calculation expression according to the calculation expression data conversion process and the electronic sticky note automatic generation process in the information generation server 10.

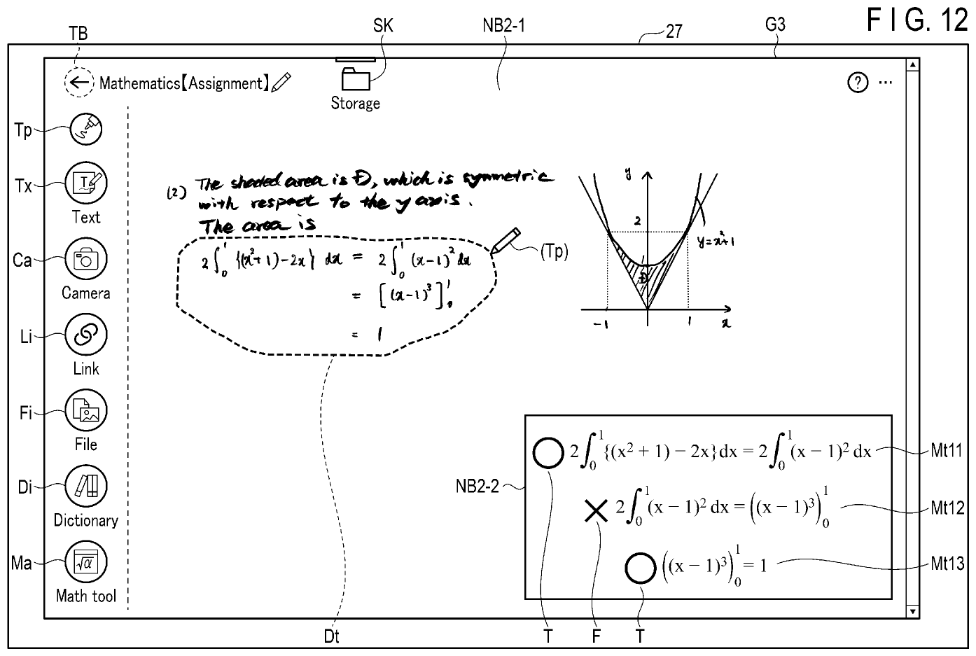

FIG. 12 is a diagram showing a display operation (part 2) on the user terminal 20 side according to the electronic sticky note automatic generation process in the information generation server 10.

Suppose information that is input in response to a user's operation is displayed on the touch-panel type display unit 27 in the user terminal 20.

In the user terminal 20, the means for inputting and displaying a user's discretionarily selected information may be a means for causing, by the control unit 21 of the user terminal 20, the touch-panel type display unit 27 to display information that is input by handwriting or with keys in response to an input of a user's discretionarily selected information by handwriting through operating a display area of the touch-panel type display unit 27 with a touch pen, or an input of user's discretionarily selected information with keys by operating a keyboard (a software keyboard in this example), or a means for causing input information to be displayed by the control unit 11 of a server device (the information generation server 10 in this example) being connected for communication.

Herein, suppose the control unit 21 of the user terminal 20 connects to the information generation server 10 in accordance with the information-generation-server-using application 22b, and the control unit 11 of the information generation server 10 causes the touch-panel type display unit 27 to display the electronic sticky note editing window G3 of the electronic sticky note (assignment) NB2-1 (second electronic sticky note) generated in the notebook (mathematics) NB2 (first display area), as shown in FIG. 9 for example.

In the electronic sticky note editing window G3 of the electronic sticky note (assignment) NB2-1 generated in the notebook (mathematics) NB2, an assignment of mathematics (a problem) that is input through the teacher's (first user) user terminal 20 (first terminal) and a calculation expression as an answer to the problem (herein a calculation expression that is transformed in multiple stages) is displayed by inputting through handwriting based on a selection of the [Text] button Tx in the student's (second user) user terminal 20 (second terminal) (step M1).

Herein, if a user wants to verify the calculation expression that has been input as an answer, for example, the user operates the trimming pen (Tp) displayed in response to the selection of the [Trimming] button Tp and encircles the range Dt including the display area in which the calculation expression is displayed to designate the range (“Yes” in step M2).

Upon receipt of an operation for designating a range Dt, the control unit 11 acquires a displayed element displayed within the display area of the designated range Dt (step M3), and performs character recognition on an image of a rectangular region (Xmin−Xmax, Ymin−Ymax) that includes the acquired displayed element (step M4).

If the character-recognized image includes a plurality of displayed elements that are distinguished as those relating to the calculation expression (“Yes” in step M5), the control unit 11 converts, in accordance with the mathematical expression display control function including a display parser, such as LaTex and Math ML, the recognized calculation expression into data in a predetermined font in a calculatable format and in a format of a math natural display mode, and the control unit 11 then causes the digitized (converted) calculation expression Mt1 to be displayed in a vacant area in which no elements are displayed in the electronic sticky note editing window G3 (the display area being displayed) (step M6). A math natural display is a mathematical notation including mathematical symbols, and a display mode of mathematics textbooks in which a plurality of displayed elements (operators and numbers) included in a calculation expression are not arranged only horizontally arranged so that a computer can recognize the calculation order and calculate them in order but spread out both horizontally and vertically so that a human can easily recognize the meaning of the calculation expression in terms of mathematics.

The control unit 11 automatically activates a mathematic tool application similarly to the case where the [Math tool] button Ma is selected, and transitions to the electronic sticky note automatic generation process (FIG. 8) (step MT).

The activation of the mathematic tool application herein is not limited to an automatic activation and the application may be activated in response to a user's operation (an operation of designation through tapping the calculation expression Mt1 or an operation of selecting the [Math tool] button Ma), while the data-converted calculation expression Mt1 is being displayed.

After the electronic sticky note automatic generation process is activated, the control unit 11 determines whether or not the calculation expression Mt1 includes an “=” (equal sign) (step T1).

If an “=” (equal sign) is included in the calculation expression Mt1 (“Yes” in step T1), the control unit 11 divides the calculation expression into equations (calculation expressions) each having a left side and a right side at every “=” (equal sign) (step T2), and generates an electronic sticky note NB2-2 (first electronic sticky note) (which differs from the electronic sticky note NB2-1 (second electronic sticky note) in this example) to which the divided calculation expressions (equations) Mt11, Mt12, and Mt13 are input and which is edited in the notebook (mathematics) NB2 (first display area) being displayed as shown in FIG. 10, and causes the electronic sticky note NB2-2 to be replaced with, for example, the calculation expression Mt1 shown in FIG. 9 and to be displayed (step T3).

At this time, if there is one “=” (equal sign) included in the calculation expression Mt1, one equation (calculation expression) having a set of a left side and a right side of the calculation expression Mt1 is input to the electronic sticky note NB2-2 and is displayed (steps T2 and T3).

The divided calculation expressions (equations) Mt11, Mt12, and Mt13 may be displayed separately in different electronic sticky notes (for example, NB2-2, NB2-3, and NB2-4).

Herein, a method of converting a calculation expression that is input in response to a user's operation into data in a predetermined font and dividing the input calculation expression into calculation expressions (equations) at each “=” (equal sign) is described with reference to FIG. 11.

Of the displayed elements included in the display area of the range Dt designated by a user by moving the trimming pen (Tp) as shown in FIG. 11(A), characters are character-recognized and encoded Cdm as a character code and the calculation expressions are encoded Cdm as a mathematical expression code by a display parser such as LaTeX, as shown in FIG. 11(B).

Even in the case where a displayed element d of a normal character is included in the user's designated range Dt, the character code is distinguished from mathematical expression code (from the mathematical expression start “\[\begin{aligned}” to the mathematical expression end “\end{aligned}\]”) and excluded, so that the mathematical expression code of the mathematical expression can be extracted.

In a mathematical expression code, the first equation Mt11 is obtained by dividing the part after the expression start “\[\begin{aligned}” and before the first “YY” as a set of a left side and a right side, the second equation Mt12 is obtained by copying (duplicating) the right side of the first equation Mt11 into the left side and dividing the part before the second “YY” as a right side, and the third equation Mt13 is obtained by copying (duplicating) the right side of the second equation Mt12 into a left side and dividing the part before the mathematical expression end “\end{aligned}\]” as a right side.

It is thereby possible to divide the calculation expression that is input in response to a user's operation into calculation expressions (equations) Mt11, Mt12, and Mt13 at every “=” (equal sign) included in the calculation expression, and to display them in the electronic sticky note NB2-2 as shown in FIG. 11(C) (steps T1 to T3).

The control unit 11 makes a true-or-false determination on an equation by comparing the left side of, for example, the calculation expression (equation) Mt1n with the right side for each divided calculation expression (equation) Mt11, Mt12, and Mt13 displayed in the electronic sticky note NB2-2 to determine whether the left side and the right side are equal (step T4), and as shown in FIG. 12, the determination result “O” T is added to the calculation expressions (equations) Mt11 and Mt13 that are determined to be correct, and the determination result “X” F is added to the calculation expression (equation) Mt12 that is determined to be erroneous (step T5).

If an “=” (equal sign) is not included in the calculation expression Mtn that is data-converted in a predetermined font and displayed in a vacant area of the electronic sticky note editing window G3 (a display area being displayed) (“No” in step T1), the control unit 11 generates the electronic sticky note NB2-n to which a calculation result of the calculation expression Mtn is added and causes it to be displayed (step T6).

It is thus possible not only to convert a discretionarily selected calculation expression that is input in response to a user's operation on the display screen of the user terminal 20 into data in a predetermined font by designating a range Dt simply by encircling a display area that includes the calculation expression so as to make it possible to use the calculation expression in a form of an electronic sticky note NBm-n of a notebook NBm, but also to use the calculation expression if the data-converted calculation expression Mt1 includes an “=” (equal sign) by dividing it at each “=” (equal sign) into calculation expressions (equations) Mt11, Mt12, and Mt13 each having a left side and a right side, and to display the electronic sticky note NB2-2 to which a result of a true-or-false determination performed on respective divided calculation expressions (equations) Mt11, Mt12, and Mt13 is added.

Even if the data-converted calculation expression Mtn does not include an “=” (equal sign), the calculation of the calculation expression Mtn can be performed and the calculation expression Mtn can be used as the electronic sticky note NB2-n to which a calculation result is added.

The data of the electronic sticky note NB2-n to which an answer to a problem generated in the above-described manner by the student's (second user) user terminal 20 (second terminal) is input may be transmitted to the teacher's (first user) user terminal 20 (first terminal) at a discretionarily selected timing (for example, step T3 (see FIG. 10) or step T5 (see FIG. 12)).

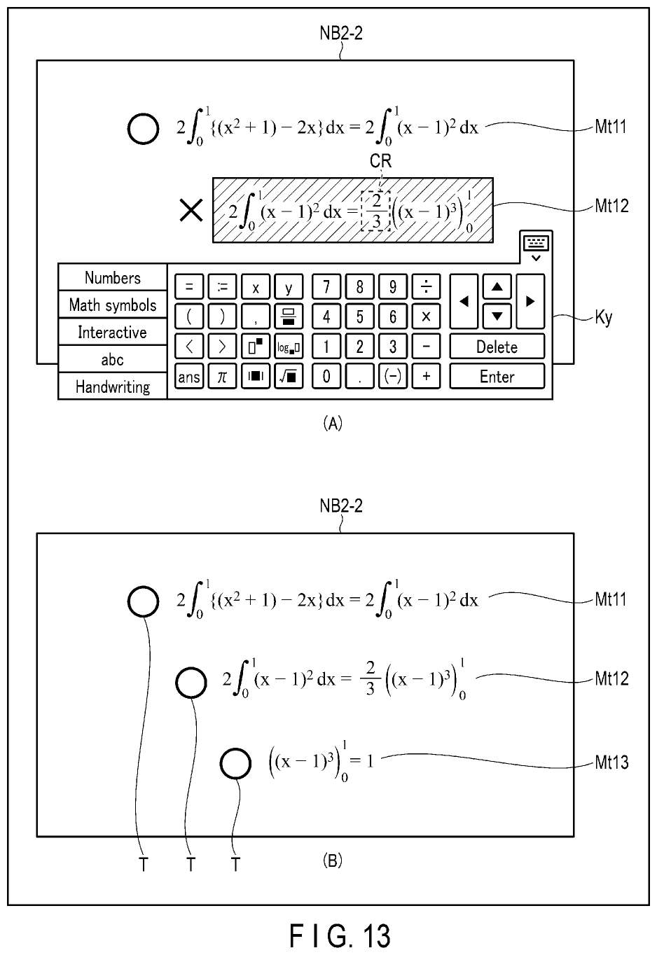

FIG. 13 is a diagram showing a display operation (part 3) on the user terminal 20 side according to the electronic sticky note automatic generation process in the information generation server 10.

FIG. 13 only shows the electronic sticky note NB2-2 from the electronic sticky note editing window G3 shown in FIG. 12.

As shown in FIG. 12, in the electronic sticky note NB2-2 displayed in the electronic sticky note editing window G3 of the electronic sticky note [Mathematics (assignment)] NB2-1, after a calculation expression included in the electronic sicky note NB2-2 (the calculation expression (equation) Mt12 to which the determination result (false) “X” F is added in this example) is designated in response to a user's operation (“Yes” in step T7), the control unit 11 causes the designated calculation expression (equation) Mt12 to be displayed in an identified manner (e.g., by reverse display) and causes the software keyboard Ky for inputting mathematical expressions in accordance with the designated calculation expression (equation) Mt12 (step T8) to be displayed, as shown in FIG. 13(A).

The designated calculation expression (equation) Mt12 is edited and changed (in this example, the fraction “⅔” CR is inserted at the top of the right side to satisfy the equation) in response to a user's operation of the software keyboard Ky (“Yes” in step T9), and the control unit 11 starts the process over from step T1 on the changed calculation expression.

In this case, as shown in FIG. 13(A), a determination result “O” T is added to the calculation expression (equation) Mt12 to which the fraction “⅔” CR has been inserted and is displayed, and the user is informed that the change made to the calculation expression (equation) Mt12 is correct (steps T1 to T5).

On the other hand, if the displayed elements in the display area designated in response to a user's operation (the range Dt designated on the electronic sticky note editing window G3 of the electronic sticky note NB2-1 shown in FIG. 12 in this example) are changed in response to a user's operation (“Yes” in step T10), the control unit 11 performs the calculation expression data conversion process (FIG. 7) at step M3 and thereafter on the displayed elements in the changed display area (Dt).

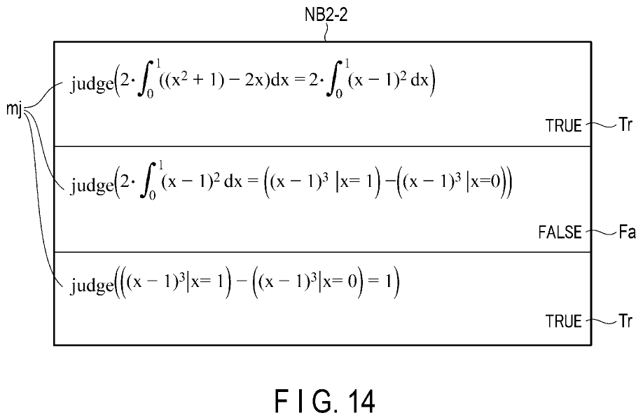

As shown in FIG. 12, for example, the display mode of the calculation expressions Mt11, Mt12, and Mt13 displayed in the electronic sticky note NB2-2 is not limited to a display mode of math natural display but may be a single-line display as shown in FIG. 14.

As shown in FIG. 12, for example, the true-or-false determination result for each of the calculation expressions (equations) Mt11, Mt12, and Mt13 displayed in the electronic sticky note NB2-2 is not limited to the display of “O” T or “X” F, and may be shown by a display of “TRUE” Tr or “FALSE” Fa along with a determination mark mj indicating a determination target as shown in FIG. 14.

FIG. 14 is a diagram showing other modes of displaying calculation expressions Mt11, Mt12, Mt13 and results of true-or-false determinations on these expressions displayed in an electronic sticky note NB2-2 in accordance with the electronic sticky note automatic generation process in the information generation server 10.

Displaying the true-or-false determination result for the calculation expression (equation) Mt1n by way of “O” T/“X” F or “TRUE”Tr/“FALSE” Fa may be switchable in accordance with a setting of the display mode selected by a user.

In accordance with steps T1 to T6, as shown in FIGS. 12 and 13 for example, if the [←] (Close) button TB is touch-operated, with the electronic sticky note NB2-2 corresponding to the calculation expression that is discretionarily input by a user on the electronic sticky note editing window G3 of the electronic sticky note (assignment) NB2-1 of the notebook (mathematics) NB2 being displayed, the control unit 11 adds the newly generated electronic sticky note NB2-2 to the notebook (mathematics) NB2 and stores it, and then updates the sticky note management table (12d) (step T11). Alternatively, if the newly generated electronic sticky note NB2-2 is dragged and dropped to the position of the [Store] icon SK, the control unit 11 adds the electronic sticky note NB2-2 dropped to the position of the [Store] icon SK to a discretionarily selected position of a user's discretionarily selected notebook NBm and stores the electronic sticky note NB2-2, and updates the sticky note management table (12d) (step T11).

For example, suppose the [←] (Close) button TB is touch-operated for storing the electronic sticky note NB2-2 at two timings, if the electronic sticky note NB2-2 including the calculation expressions (equations) Mt11, Mt12, and Mt13 and the true-or-false determination results “O” T, “X” F, “O” T are generated and displayed as shown in FIG. 12, and if the electronic sticky note NB2-2 including the calculation expressions (equations) Mt11, Mt12, and Mt13 and the true-or-false determination results “O” T, “O” T, “O” T are generated and displayed as shown in FIG. 13(B).

Then, as shown in FIG. 3, in the sticky note management table (12d), in addition to the electronic sticky note (assignment) NB2-1 that has already been present in the notebook (mathematics) NB2, an electronic sticky note (point 1) NB2-2 whose name is “point 1” and which includes the calculation expressions (equations) Mt11, Mt12, and Mt13 shown in FIG. 12 and the true-or-false determination results for the expressions, “O” T, “X” F, “O” T, is stored at a first timing, and an electronic sticky note (point 2) NB2-3 whose name is “point 2” and which includes the calculation expressions (equations) Mt11, Mt12, and Mt13 shown in FIG. 13(B) and the true-or-false determination results for the expressions, “O” T, “O” T, “O” T, is stored at a second timing.

FIG. 15 is a diagram showing a notebook window G2 of a notebook (mathematics) NB2 including the electronic sticky note (point 1) NB2-2 and the electronic sticky note (point 2) NB2-3 newly added to the notebook (mathematics) NB2 in accordance with the electronic sticky note automatic generation process in the information generation server 10.

In accordance with the above-described electronic sticky note automatic generation process (FIG. 8), an electronic sticky note NB2-2 including a calculation expression is newly generated in the electronic sticky note editing window G3 of the electronic sticky note (assignment) NB2-1 of the notebook (mathematics) NB2 as shown in FIGS. 12 and 13, and after the notebook icon (mathematics, NB2) is designated in the notebook listing window G1 shown in FIG. 6(A), with the electronic sticky note (point 1) NB2-2 and the electronic sticky note (point 2) NB2-3 additionally stored in association with the notebook (mathematics) NB2 of the sticky note management table (12d) as shown in FIG. 3, the control unit 11 causes the electronic sticky note (assignment) NB2-1, the electronic sticky note (point 1) NB2-2, and the electronic sticky note (point 2) NB2-3 to be displayed on, as shown in FIG. 15, the notebook window G2 of the notebook (mathematics) NB2 based on the sticky note management table (12d) (step S1, FIG. 5).

For the electronic sticky note (assignment) NB2-1, the electronic sticky note (point 1) NB2-2, and the electronic sticky note (point 2) NB2-3 displayed on the notebook window G2 of the notebook (mathematics) NB2, an electronic sticky note NB2-n can be discretionarily selected (“Yes” in step S6), and the selected electronic sticky note NB2-n can be added and edited based on the notebook menu MN (step S4), as described earlier.

### Summary of Embodiment

According to the information generation server 10 (information generation apparatus) of the embodiment, a calculation expression that is input as an answer to an assignment (user's discretionarily input calculation expression) is displayed through handwriting or key entry in the electronic sticky note editing window G3 (the touch-panel type display unit 27 of the user terminal 20) of the electronic sticky note (assignment) NB2-1 (second electronic sticky note) generated in the notebook (mathematics) NB2 (first display area), and in response to designation of a display area in the range Dt including the input calculation expression with a trimming pen (Tp), for example, the calculation expression is recognized based on trajectories of the displayed elements included in the designated range Dt, and the calculation expression is displayed, as a calculation expression Mt1 converted into data in a determined font, in a vacant area that does not overlap the displayed elements in the display window, and a mathematical tool application is activated at the same time.

If an “=” (equal sign) is included in the data-converted calculation expression Mt1, the calculation expression Mt1 is divided into calculation expressions (equations) Mt11, Mt12, and Mt13 each having a left side and a right side at every “=” (equal sign), and the electronic sticky note NB2-2 (first electronic sticky note) showing the calculation expressions (equations) Mt11, Mt12, and Mt13 is generated and displayed. If an “=” (equal sign) is not included in the data-converted calculation expression Mtn, an electronic sticky note NB2-2 (first electronic sticky note) showing the calculation expression Mtn is generated and displayed.

A true-or-false determination is made on each of the calculation expressions (equations) Mt11, Mt12, and Mt13 of the electronic sicky note NB2-2, and the determination result (True) “O” T or (False) “X” F is added to the sticky note and displayed.

In the electronic sticky note NB2-2, in response to a designation of the calculation expression (equation) Mt12 determined to be false “X” F as an equation, the software keyboard Ky for inputting mathematical expressions is displayed, and in response to a change (CR) made to the calculation expression (equation) Mt12 by a user's operation on the software keyboard Ky, a true-or-false determination is once again made on the changed calculation expression (equation) Mt12 (every time a change is made), and the determination result is updated and displayed.

Even in the case where the electronic sticky note NB2-2 of the calculation expression Mtn that does not include an “=” (equal sign) is generated and displayed, the software keyboard Ky is displayed in response to designation of the calculation expression Mtn, and in response to a change of the calculation expression Mt1n by a user's operation on the software keyboard Ky, a calculation of the changed calculation expression Mt1n is once again performed (every time a change is made) and the calculation result is updated and displayed.

It can be naturally understood that not only the true-or-false determination on the calculation expression Mt1n that includes an “=” (equal sign) and a calculation of the calculation expression Mtn that does not include an (equal sign) but also other calculation processes in accordance with the functions of a mathematical tool application can be performed on the calculation expression Mt1n (Mtn) of the electronic sticky note NB2-2.

The electronic sticky note NB2-2 (first electronic sticky note) newly generated in the electronic sticky note editing window G3 for the electronic sticky note (assignment) NB2-1 (second electronic sticky note) in the notebook (mathematics) NB2 (first display area) is added to and stored in the notebook (mathematics) NB2 (first display area) in response to an operation of the [←] (close button) TB. The newly generated electronic sticky note NB2-2 (first electronic sticky note) is added to and stored in a discretionarily selected position in a user's discretionarily selected notebook NBm (another display area) in response to a drag-and-drop operation of moving the sticky note NB2-2 to the position of the [Store] icon SK.

Thus, according to the information generation server 10 (information generation apparatus) according to the embodiment, it is possible not only to recognize a calculation expression displayed in a display area and convert it into data in a predetermined font, to perform a calculation of a data-converted calculation expression, or to determine true or false of the data-converted calculation expression, but also to generate an electronic sticky note NBm-n showing the data-converted calculation expressions so that it can be added (pasted) to a discretionarily selected notebook NBm and to perform various processing using a mathematical tool application.

It is therefore possible to effectively use a calculation expression that is input in response to a user's operation.

The methods of the processes performed by the information generation system 1 described in the foregoing embodiments, namely the electronic sticky note generation process shown in the flowchart of FIG. 5, the calculation expression data conversion process shown in the flowchart of FIG. 7, and the electronic sticky note automatic generation process shown in the flowchart of FIG. 8, can be stored in a storage medium, such as a memory card (a ROM card or a RAM card), a magnetic disk (a floppy (registered trademark) disk, a hard disk, or the like), an optical disk (CD-ROM, DVD, or the like), and a semiconductor memory, and can be distributed, as a computer-executable program. Furthermore, a computer (CPU) of an information processing apparatus (electronic device) reads the program stored in the medium of the external storage apparatus, and the operations can be executed and controlled based on the read programs, thereby realizing the various functions described in the embodiments, and executing processing similar to the above-described processes.

The data of the programs for realizing each of the processes can be transmitted on a communication network (N) in a form of program codes, and data of the programs is obtained from a computer apparatus (program server) connected to this communication network (N) and imported to an information processing apparatus (electronic device), and stored in a storage apparatus, thereby realizing the above-described functions.

The present invention is not limited to the embodiment and various modifications can be made without departing from the scope of the present invention in practical stages. The embodiments may be appropriately combined, and if combined, combined effects are obtained. In addition, the embodiments include inventions of various stages, and a variety of inventions can be derived by properly combining structural elements of one embodiment or by properly combining structural elements of different embodiments. For example, if the object of the invention is achieved and the advantages of the invention are attained even after some of the structural elements disclosed in connection with the embodiments are deleted, the structure made up of the resultant structural elements can be extracted as an invention.

What is claimed is:

1. An information generation apparatus configured to perform a process of:
receiving a user's operation that designates a range in a first display area in which information that is input in accordance with a user's operation is displayed;
recognizing a calculation expression from displayed elements included in the designated range; and
generating a first electronic sticky note that can be arranged and displayed at a designated position in a designated display area and to which a first calculation expression, which is the recognized calculation expression, is input.

2. The information generation apparatus according to claim 1 configured to perform a process of:
displaying in the first display area a mathematical problem that is input by a first user who operates a first terminal;
displaying in the first display area a calculation expression that is input as an answer to the mathematical problem by a second user who operates a second terminal; and
with the mathematical problem and the calculation expression being displayed in the first display area, transmitting to the first terminal the first electronic sticky note to which the first mathematical expression is input, if a range is designated in which the calculation expression that is input as an answer is encircled, the first mathematical expression being a result of recognition of the calculation expression that is input as an answer.

3. The information generation apparatus according to claim 1 configured to perform a process of:
if a calculation element of the recognized calculation expression includes an equal sign, generating the first electronic sticky note, with information indicating a result of comparison between a left side and a right side of the equal sign being added to the first calculation expression.

4. The information generation apparatus according to claim 1 configured to perform a process of:
if a calculation element of the recognized calculation expression includes a plurality of equal signs, generating the first electronic sticky note, with information indicating a result of comparison between a left side and a right side of each of the equal signs being added to the first calculation expression.

5. The information generation apparatus according to claim 4 configured to perform a process of:
if each of the plurality of equal signs included in the recognized calculation expression corresponds to a stage of expression transformation, copying a right side of an immediately previous stage to a left side of a stage in which the left side is omitted, and generating the first electronic sticky note by inputting a plurality of equations divided at the plurality of equal signs.

6. The information generation apparatus according to claim 5 configured to perform a process of:
generating a plurality of the first electronic sticky notes to which a plurality of equations respectively divided at the plurality of equal signs are respectively input.

7. The information generation apparatus according to claim 4 configured to perform a process of:
if a user's operation for updating the first calculation expression that has been input to the first electronic sticky note is received, generating the first electronic sticky note, with information indicating a result of comparison between a left side and a right side of the equal sign of the updated first calculation expression being added thereto.

8. The information generation apparatus according to claim 1 configured to perform a process of:
converting, among a plurality of displayed elements included in the designated range, a plurality of displayed elements distinguished to be display elements relating to a calculation expression into a format calculatable as a calculation expression and displayable in a display mode of a math natural display, and inputting the converted displayed elements to the first electronic sticky note.

9. The information generation apparatus according to claim 8 configured to perform a process of:
displaying the calculation expression that has been input to the first electronic sticky note in a display mode of a math natural display; and
displaying information based on a calculation result of the calculation expression that has been input to the first electronic sticky note, in association with the calculation expression.

10. The information generation apparatus according to claim 1, wherein
the apparatus has a function of a mathematical tool with which calculation of a designated calculation expression is possible, and
the apparatus is configured to perform a process of causing the mathematical tool to perform calculation relating to the first calculation expression that has been input to the first electronic sticky note if the mathematical tool is activated for the first electronic sticky note as a target.

11. The information generation apparatus according to claim 10 configured to perform a process of:
activating the mathematical tool in response to a recognition of a calculation expression from displayed elements included in the designated range.

12. The information generation apparatus according to claim 1, wherein
the apparatus has a function of generating a plurality of notebooks each having different displayed areas, the notebooks managing content of an electronic sticky note arranged in each display area and a position at which the electronic sticky note is arranged within each display area,
wherein the first display area is a display area managed as a first notebook, and
wherein the information generation apparatus is configured to perform a process of associating the generated first electronic sticky note with a user's designated position within a display area of a user's designated notebook differing from the first notebook and managing the first electronic sticky note.

13. The information generation apparatus according to claim 1 configured to perform a process of:
arranging and displaying the recognized first calculation expression at a position that does not overlap displayed elements corresponding to the recognized calculation expression in the first display area.

14. The information generation apparatus according to claim 13 configured to perform a process of:
arranging and displaying the generated first electronic sticky note at a user's designated position in the user's designated display area.

15. The information generation apparatus according to claim 1, wherein
the first display area is a display area of the first electronic sticky note, and
the information generation apparatus is configured to perform a process of editing the first electronic sticky note in such a manner that the first calculation expression is input into the display area of the first electronic sticky note.

16. The information generation apparatus according to claim 1, wherein
the first display area is a display area of a second electronic sticky note displaying information that has been input in response to a user's operation, and
the information generation apparatus is configured to perform a process of generating the first electronic sticky note as an electronic sticky note differing from the second electronic sticky note.

17. An information generation method comprising causing an information generation apparatus to perform a process of:
receiving a user's operation for designating a range in a first display area displaying information that is input in response to a user's operation;
recognizing a calculation expression from displayed elements included in the designated range; and
generating a first electronic sticky note that can be arranged and displayed at a designated position in the designated display area and to which a first calculation expression, which is the recognized calculation expression, is input.

18. A non-transitory storage medium storing a program for causing a control unit of an information generation apparatus to function to perform a process of:
receiving a user's operation for designating a range in a first display area displaying information that is input in response to a user's operation;
recognizing a calculation expression from displayed elements included in the designated range; and
generating a first electronic sticky note that can be arranged and displayed at a designated position in the designated display area and to which a first calculation expression, which is the recognized calculation expression, is input.
